(19) United States
(12) Patent Application Publication
(10) Pub. No.: US 2017/0332153 A1
(43) Pub. Date: Nov. 16, 2017

(54) Telephone Call Processing

(71) Applicant: Ultra Communications Ltd, Fareham Hampshire (GB)

(72) Inventors: Craig Shilling, (GB); Tom Davies, (GB); Darren Sullivan, (GB); James Sumner, (GB); Robert Wray, (GB); Robert Bates, (US)

(21) Appl. No.: 15/535,314

(22) PCT Filed: Dec. 11, 2015
(86) PCT No.: PCT/GB2015/053808

§ 371 Date: Jun. 12, 2017

(30) Foreign Application Priority Data
Dec. 11, 2014 (GB) 1422064.4

(51) Int. Cl. H04Q 1/46; H04M 3/02

(52) U.S. Cl. CPC H04Q 1/46; H04M 3/02; H04M 2203/551; H04M 2203/2027

(57) ABSTRACT

Method and system for processing a telephone call comprising initiating a telephone call. Taking a first action if the telephone call is answered before a call alert is initiated. Taking a second action if the telephone call is answered after the call alert is initiated. Furthermore, a first action may be taken if the telephone call is answered before a call alert is initiated or if the telephone call is answered within a time period following the call alert being initiated. The second action may be taken if the telephone call is answered after expiry of the time period following the call alert being initiated.

### FIELD OF THE INVENTION

The present invention relates to a method and system for processing telephone calls and in particular determining whether a person or machine has answered a call.

### BACKGROUND OF THE INVENTION

When calling a telephone number, it is usually the intention of the caller to be connected to a live person. However, telephone systems including cellular networks and wired systems, commonly include voicemail and other automated answering systems. These automated answering systems may accept the call when the live person is unavailable, already engaged in another call or perhaps has their handset (e.g. mobile telephone) turned off. Having a call answered by an automated system may be acceptable in person-to-person calls but this can be problematic in other scenarios, especially within call centre operations that employ automatic calling systems. Such call centres may be involved in telemarketing, customer relationship management and debt collection campaigns, for example. In such systems, calls may be set up automatically and on connection they are transferred to a call centre staff member or agent. Reducing the occurrence of call centre agents entering into calls that involve an automated answering system or other machine is important for improving call centre productivity.

U.S. Pat. No. 7,680,260 describes a system for detecting the occurrence of a voicemail system answering a call. This system measures the time interval between when a call is transmitted to a mobile switching centre and when an indication is received that the call has been answered. If this time interval is no greater than a threshold then the call is ended (i.e. assumed to be an answer system).

However, calls between different systems may differ in the actual connection time and so calls that take longer to connect but are answered by an answering machine may be allowed to continue erroneously in the system of U.S. Pat. No. 7,680,260. Furthermore, calls to live persons may also be disconnected incorrectly in situations where the call is connected particularly quickly (i.e. within the time threshold). This can cause inconvenience to the called party, a loss of productivity and may also be against local telecommunications regulations.

Therefore, there is required a method and system that more accurately discriminates between live callers and automated answering processes.

### SUMMARY OF THE INVENTION

When a call is placed, various signals may pass over the line. These signals can be used to monitor the progress of the call and events that take place. Different telecommunications systems use different forms and standards for these signals.

The events that take place (and can be signalled over the line or connection) include: call setup, call proceeding, call alerting (e.g. early media signally or ringing), and call connected.

When the call is connected at a particular point or time in the process then this can indicate that either a live person or not (e.g. an answering machine, IVR process, or other machine) has answered and been connected to the call.

If the call is answered before the call alerting event occurs then this is interpreted as a non-human answering condition. This can occur because the machine, computer or internal process that answers the call does not need to wait for a call alerting event or signal before detecting a call.

Similarly, a call being answered very soon after the call alerting event can also indicate that a machine (or non-human process) has answered.

Either of these scenarios may be used separately or in combination.

“Very soon after” can be a time period, predetermined or configurable time interval. For example, this can be any time from the call alerting event (time zero) onwards (e.g. 0-50 ms, 0-100 ms, 0-500 ms, 0-1 s, etc.) Shorter time intervals can be used to reduce the occurrence of disconnecting live recipients. Longer time intervals can be used to reduce the occurrence of connecting to non-humans. The time interval may also be dynamically set based on historic or live results. For example, as the number or frequency (per call or over time) of non-human connections increases then the time interval can be increased to lower the number or frequency. The time interval may also be dynamically reduced as reports of disconnections to live recipients increase.

The system and method may operate in real time on current calls or be used to analyse historic or stored data. For example, calls may be analysed to determine what particular interval (after the call alert) to set in order to discriminate live from non-live called parties. For example, this may be set so that a certain percentage of calls to live people are not disconnected (e.g. 99%, 99.9%, 99.99%, 99.999%, etc.)

A telephone call may include voice only calls, video calls or other types of communication or where a communication event is set up between devices or two or more parties.

According to a first aspect there is provided a method of processing a telephone call comprising the steps of:

initiating a telephone call;

taking a first action if the telephone call is answered before a call alert is initiated; and

taking a second action if the telephone call is answered after the call alert is initiated. The call alert is for example, a signal that indicates that the remote or called party or recipient communication device has been alerted to the call. This could be a ringing signal or similar.

According to a second aspect there is provided a method of processing a telephone call comprising the steps of:

initiating a telephone call;

taking a first action if the telephone call is answered within a time period following a call alert being initiated; and

taking a second action if the telephone call is answered after expiry of the time period following the call alert being initiated.

The first and second aspects may be combined or used separately and have advantages over the prior art.

According to a third aspect there is provided a method of processing a telephone call comprising the steps of:

initiating a telephone call;

taking a first action if the telephone call is answered before a call alert is initiated or if the telephone call is answered within a time period following the call alert being initiated; and

taking a second action if the telephone call is answered after expiry of the time period following the call alert being initiated.

Therefore, the methods may have different outcomes or actions depending on the point or time that the call was answered. The actions may be to disconnect or allow the call to continue or be different actions, for example. The first action could also to allow the call to proceed but direct it to an automatic process. For example, this could be to leave a message or enter an IVR process (e.g. press a key to be put through to a live agent).

The first action may be to make one decision about call routing or processing and the second action may be a different decision about call routing or processing.

Optionally, the first action may be terminating the call and the second action is allowing the call to proceed. Therefore, calls to non-humans (machines) may be avoided improving efficiency of a call centre or telecommunications network.

Optionally, the first action may be determining that the call has been answered by a non-human and the second action is determining that the call has been answered by a human. This information may be used by further processes. For example, the call may be allowed to continue but not be directed immediately to a live agent. This can be useful when an IVR system is encountered and handled automatically.

Advantageously, the non-human may be an answering machine, voicemail, digital assistant, artificial intelligence, a computer, machine, or an interactive voice response, IVR, processor or other device.

Preferably, the method may further comprise the step of receiving a signal indicating that the call alert has been sent. This signal may be sent according to a telecommunications standard, for example. This signal therefore provides an indication of the call alert event.

Optionally, the method may further comprise the steps of:

receiving a signal indicating that the call has been set up; and

receiving a signal indicating that the call is proceeding. Therefore, the decision may not be made (or the method started) until either or both of these signals are received.

Optionally, the call alert may be a ringing telephone or early media signalling. Other call alerts may be encountered and detected. This may be any type of audio, for example.

Preferably, the method may further comprise the steps of determining that the telephone call has been answered, and determining that the call alert is initiated, based on call progress signalling events.

Optionally, the first action may be to allow the call to proceed provided one or more criteria are met. In other words, additional safeguards or rules may be in place to prevent desirable calls from being lost.

Optionally, the one or more criteria may be any one or more of:

determining that a previous telephone call to the same number was successful;

determining that the telephone call is the first time that the telephone number has been called;

determining that a previous telephone call to the same number exceeded a predetermined time; (e.g. it should have resulted in a conversation with a person. Shorter calls may indicate a non-human answer); and/or

determining that a previous telephone call to the same number was connected to an IVR processor. In other words, the history (or lack) of the called party may be considered when a decision to disconnect is taken. For example, some establishments always automatically answer all incoming calls but these should not necessarily be terminated. The history of these particular numbers can then be considered during future calls. Successful may be defined as a previous call being classified (by a previous agent) as useful, or being able to speak to a person.

Optionally, the telephone call may be initiated using voice over IP, VoIP, or integrated services digital network, ISDN protocols. Other telephone calling technology may be used such as session initiation protocol (SIP) and primary rate interface (PRI), for example.

According to a fourth aspect there is provided a method of analysing telephone call data comprising the step of:

determining from telephone call data that a telephone call was answered by a non-human if the telephone call data indicates that the telephone call was answered before a call alert was initiated.

According to a fifth aspect there is provided a method of analysing telephone call data comprising the step of: determining from telephone call data that a telephone call was answered by a non-human if the telephone call data indicates that the telephone call was answered within a time period (e.g. specific or predetermined time period) following a call alert being initiated.

According to a sixth aspect there is provided a method of analysing telephone call data comprising the step of:

determining from telephone call data that a telephone call was answered by a non-human if the telephone call was answered before a call alert was initiated or if the telephone call was answered within a time period (e.g. specific or predetermined time period) following the call alert being initiated.

The fourth, fifth or sixth aspects may therefore operate on historic or stored data. Therefore, the accuracy or effectiveness of the system may be determined and parameters set (e.g. setting the time period or threshold to be used in the first to fourth aspects—time period after the call alert is initiated). Particular telephone numbers may also be purged or removed from future calls based on this analysis (e.g. if non-human answering is detected or above a predetermined frequency). This analysis may also be used to determine and prove that telecommunications regulations are being adhered to (e.g. minimising or reducing calls that are disconnected erroneously or when a human answers a call). Therefore, this may avoid the need to manually analyse voice calls. Non-humans may be any automated process or machine described throughout this disclosure.

Following the determination being made (that a human or non-human answered the call) then further actions, analysis or processing may take place. This analysis may be used to improve the call routing or processing of live calls.

According to a seventh aspect there is provided a system comprising a processor or logic configured to:

initiate a telephone call;

take a first action if the telephone call is answered before a call alert is initiated; and

take a second action if the telephone call is answered after the call alert is initiated.

According to a eighth aspect there is provided a system comprising a processor configured to:

initiate a telephone call;

take a first action if the telephone call is answered within a time period following a call alert being initiated; and

take a second action if the telephone call is answered after expiry of the time period following the call alert being initiated.

According to an ninth aspect there is provided a system comprising a processor configured to:

initiate a telephone call;

take a first action if the telephone call is answered before a call alert is initiated or if the telephone call is answered within a time period following the call alert being initiated; and

take a second action if the telephone call is answered after expiry of the time period following the call alert being initiated.

Advantageously, the system may further comprise a telephone interface or other components configured to initiate the telephone call.

According to a tenth aspect there is provided a call centre comprising the systems of any of aspects seven to nine.

The methods described above may be implemented as a computer program comprising program instructions to operate a computer. The computer program may be stored on a computer-readable medium.

The computer system may include a processor such as a central processing unit (CPU). The processor may execute logic in the form of a software program. The computer system may include a memory including volatile and non-volatile storage medium. A computer-readable medium may be included to store the logic or program instructions. The different parts of the system may be connected using a network (e.g. wireless networks and wired networks). The computer system may include one or more interfaces. The computer system may contain a suitable operating system such as UNIX, Windows (RTM) or Linux, for example.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a schematic diagram of a call centre including automated calling equipment;

FIG. 2 shows a schematic diagram of a timeline of events occurring during a call;

FIG. 3 shows a schematic diagram of a method for processing a call using the call centre of FIG. 1, given by way of example only;

FIG. 4 shows a schematic diagram of the automated calling equipment of FIG. 1;

FIG. 5 shows a schematic diagram of a system for analysing telephone call data generated within the call centre of FIG. 1;

FIG. 6 shows a flowchart of a method of processing a telephone call;

FIG. 7 shows a flowchart of an alternative method for processing a telephone call; and

FIG. 8 shows a flowchart of a further method for processing a telephone call given by way of example only.

It should be noted that the figures are illustrated for simplicity and are not necessarily drawn to scale. Like features are provided with the same reference numerals.

### DETAILED DESCRIPTION OF THE PREFERRED EMBODIMENTS

In an embodiment, a call to a communications device over the public telephone network is established. A series of call progress signalling events may be employed by the network and attached communications devices to facilitate the proper handling of the call. Based on a temporal sequence analysis of network call progress signalling events, a determination can be made of whether the recipient is a live person or an answering machine (or other automated process).

When a call to a communications device over the public telephone network is setup, a series of call progress signalling events may be employed by the network and attached communications devices in accordance with standard call establishment protocols (including but not limited to those specified by the Session Initiation Protocol (SIP) IETF RFC 3261 and Q931 ITU standards). The call progress signalling events can indicate availability or otherwise of network service facilities and the current state of a call as it traverses the network. The call progress signalling events can indicate if the call setup is proceeding; if early media such as audible network messages and in some cases audible ring back tone is available; if the recipient communications device has been alerted to the presence of an incoming call; if the call has been answered; and/or if the call has disconnected.

Answering machines (which in this description may be any automated process or call answering process) may be activated by recipient communications devices after a period of alerting has expired or if the communications device is otherwise immediately unavailable to process an incoming call. An answering machine activated due to a communications device being immediately unavailable will typically answer immediately after a call progress signalling event indicating that the call setup is proceeding or otherwise, or within a short period after one or more subsequent call progress signalling events indicating that the recipient communications device has been alerted to the presence of an incoming call.

The following describes a method of handling call progress signalling events that can determine whether the recipient is a live person or a machine.

FIG. 1 shows a schematic illustration of an example call centre operation 100 using an automated calling system 102 to establish calls 103 over the public telephone network 104 on behalf of live agents 101 to recipient communications devices 105.

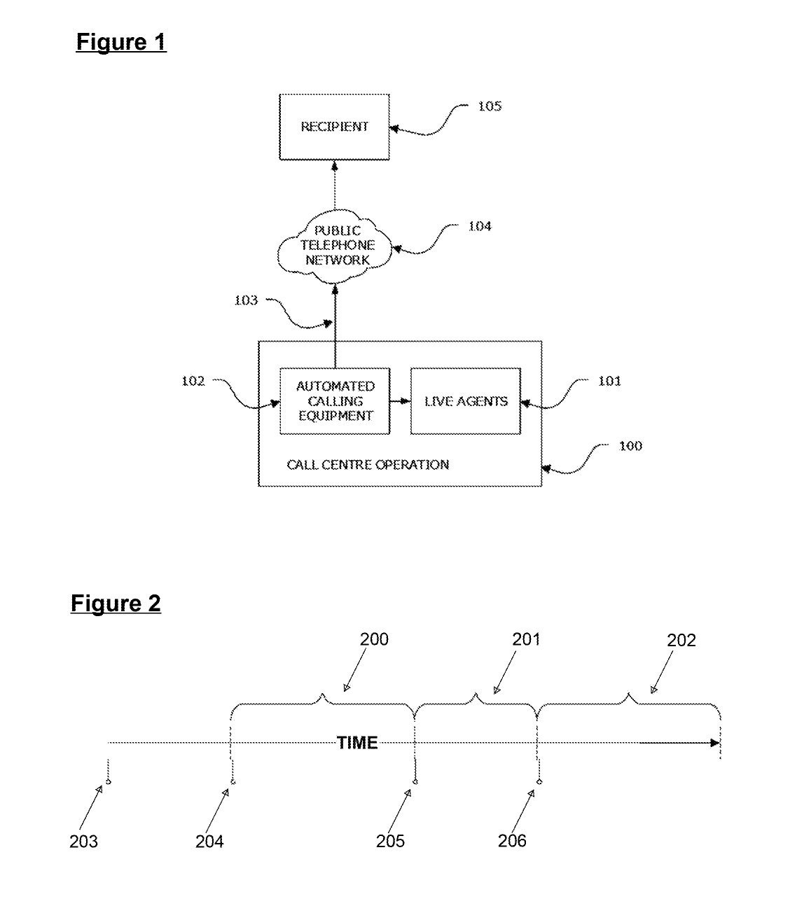

FIG. 2 shows a timeline showing a temporal sequence of events associated with establishing a call over the public telephone network comprising call progress signalling events 203, 204, 205, time intervals 200, 201, 202 pertinent to the method and a configurable threshold 206 which defines the period within which an answered call can be determined to be connected to a machine.

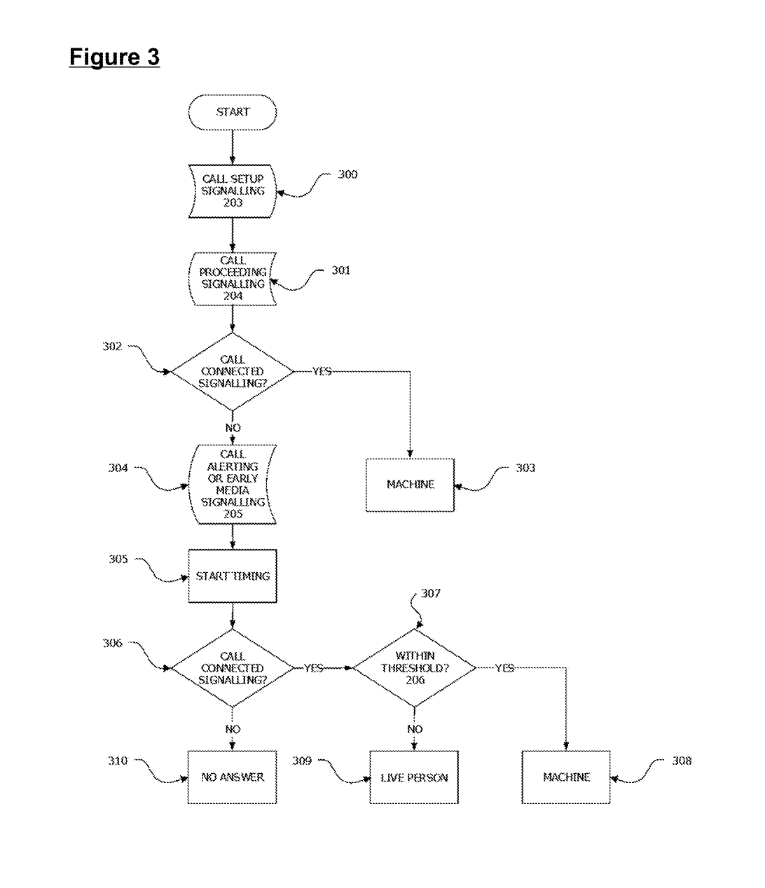

FIG. 3 shows a flowchart the method to make a determination of whether a call has been answered by a live person or a machine.

FIG. 1 shows a simplified illustration of an example contact centre operation 100 and represents the business process of establishing calls 103 over the public network 104 to a recipient communications device 105 on behalf of live call centre agents 101. Amongst other processes, the contact centre operation 100 establishes calls resulting in a successful connection to either a live person or an answering machine. All other call outcomes are not relevant to this disclosure. The process is expanded specifically with regard to the pertinent call progress signalling events described with reference to FIGS. 2 and 3. FIG. 2 represents the temporal sequence of events and time intervals inherent to the process while FIG. 3 defines the an example process flow.

1. A call 103, 203, 300, is initiated by the automatic calling system 102 in accordance with the protocol employed by the local network service provider. A call progress signalling event 204, 301 is received indicating that the call setup is proceeding.

a. If a call progress signalling event is received indicating that the call has been answered 302 within the subsequent period 200 (i.e. before the call alert) then a determination is made that the call has been answered by a machine 303 or other non-human or process.

b. If a call progress signalling event is received indicating that the recipient communications device has been alerted to the presence of an incoming call; or that early media such as network messages or ring back tone is available 205, 304; within the subsequent period 200, then a timer 305 is started.

2. If a call progress signalling event is received indicating that the call has been answered 306 within the subsequent period 201 defined by a configurable threshold 206 a determination is made 307 that the call has been answered by a machine 308.

3. If a call progress signalling event is received indicating that the call has been answered 306 in the subsequent period 202 (i.e. after expiry of the time period) then a determination is made 307 that the call has been answered by a live person 309.

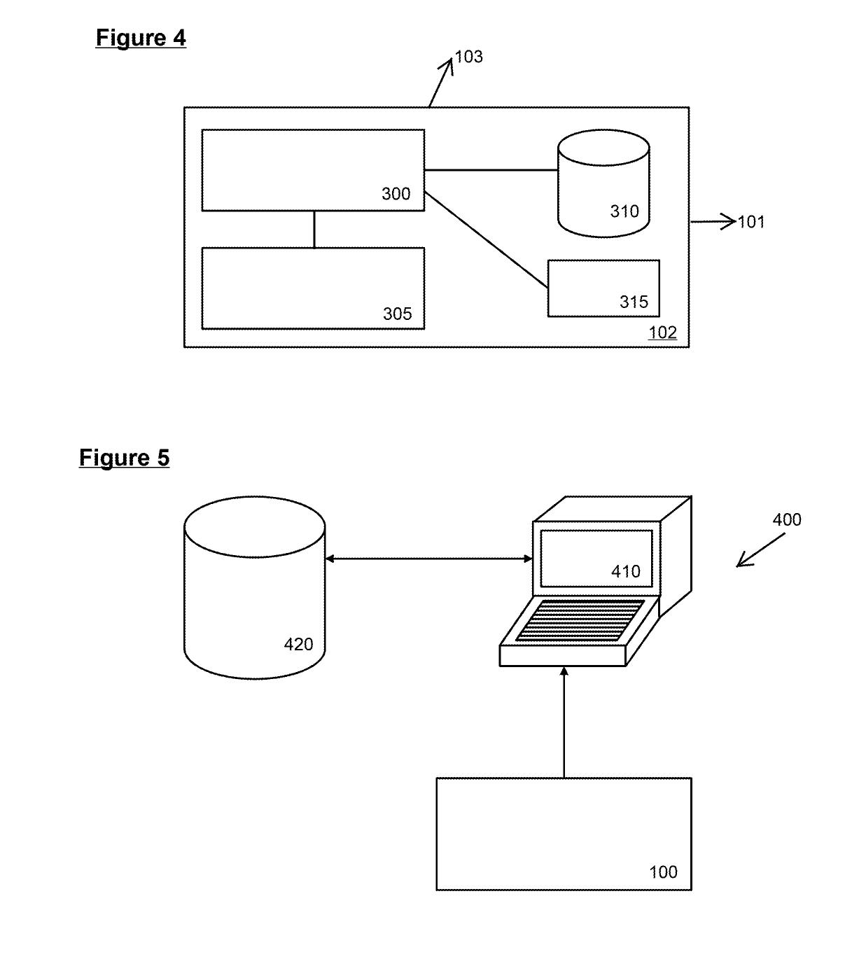

FIG. 4 shows a schematic diagram of the automated calling equipment of FIG. 1 shown in more detail. This automated calling equipment implements the various methods described throughout this disclosure.

A processor 300 carries out logic to implement the methods. Persistent storage or database 310 may be used to store processing instructions, computer programs, an operating system (e.g. Windows, Linux, OSX, UNIX, etc.), parameters (e.g. timing thresholds and other configurable variables) and historic data of previous telephone calls. The automated calling equipment 102 also contains memory 305 (e.g. RAM) and a telephone interface 315.

FIG. 5 shows a schematic diagram of a system 400 for processing telephone call data. Processor or server 410 runs a suitable operating system (e.g. Windows, UNIX, OSX, Linux or similar). Database 420 may be internal or external to the computer system 410 and stores the historic telephone call data. The telephone data is provided to the system 400 from the call centre operation 100 either directly or indirectly over a network or other suitable medium.

FIG. 6 illustrates a flowchart of a method 500 for processing a telephone call. A call is initiated at step 510. At step 520, it is determined whether or not the telephone call was answered before the call alert. If it was answered beforehand, then a first action 530 is taken. If it was not answered beforehand, then a second action 540 is taken. The first action 530 may be for example to terminate the call or apply further tests and criteria. The second action 540 may be to allow the call to proceed.

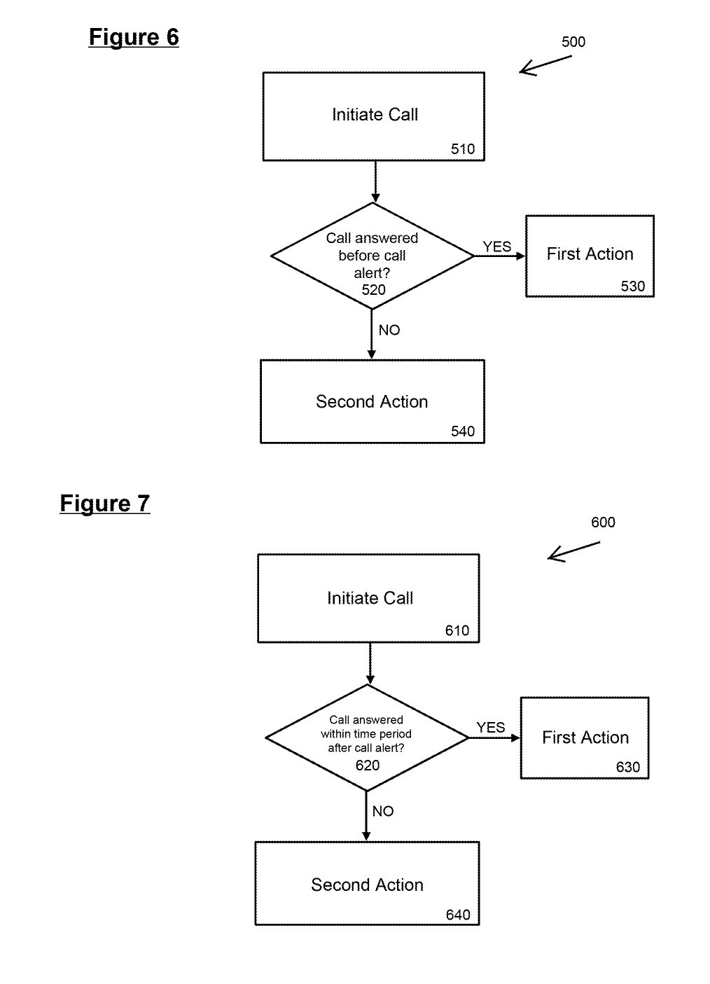

FIG. 7 illustrates a flowchart of an alternative method 600 of processing a telephone call. Again, a telephone call is initiated at step 610. At step 620, it is determined whether or not the call was answered within a time period following the call alert. If the call is answered within this time period, then the first action 630 is taken. If the call was not answered within this time period (i.e. later) then the second action 640 is taken. Again, the first action 530 may be for example to terminate the call or apply further tests and criteria. The second action 540 may be to allow the call to proceed.

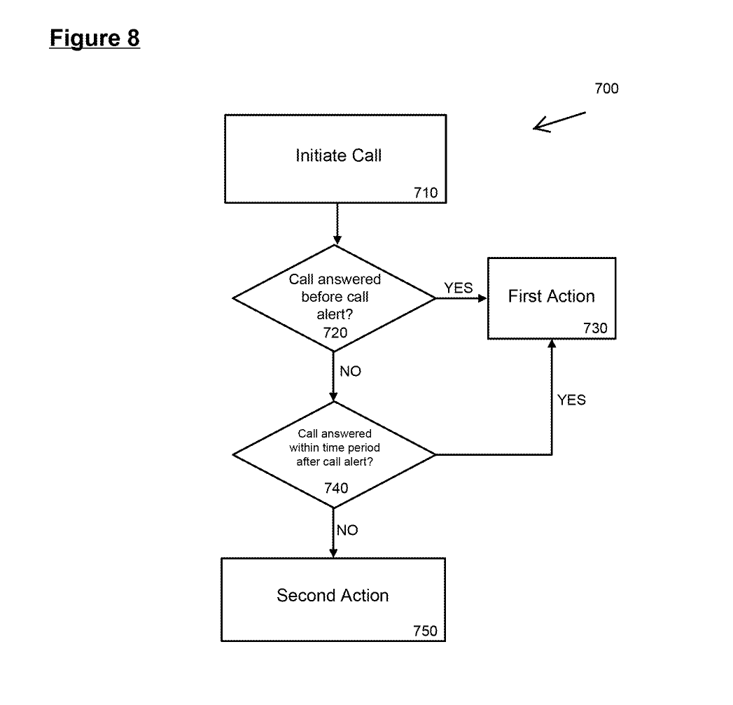

FIG. 8 shows a flowchart of a further method 700 for processing a telephone call. In essence, this method 700 is a combination of methods 500 and 600.

At step 710, the call is initiated. Step 720 is to determine whether or not the call was answered before the call alert. If yes, then the first action 730 is taken. If no then a further determination is made. This further determination is whether or not the call was answered within a time period following the call alert. If yes, then the first action 730 is taken and if no, then the second action 750 is taken. Again, the first action 530 may be for example to terminate the call or apply further tests and criteria. The second action 540 may be to allow the call to proceed.

As will be appreciated by the skilled person, details of the above embodiment may be varied without departing from the scope of the present invention, as defined by the appended claims.

For example, the method is described as being carried out with a call centre but this may instead be carried out elsewhere (e.g. by domestic users). The telephone systems described are fixed line telephone systems. However, the system and method may also be implemented in a mobile or cellular environment.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A method of processing a telephone call comprising the steps of:
initiating a telephone call;
taking a first action if the telephone call is answered before a call alert is initiated; and
taking a second action if the telephone call is answered after the call alert is initiated.

2. A method of processing a telephone call comprising the steps of:
initiating a telephone call;
taking a first action if the telephone call is answered within a time period following a call alert being initiated; and
taking a second action if the telephone call is answered after expiry of the time period following the call alert being initiated.

3. A method of processing a telephone call comprising the steps of:
initiating a telephone call;
taking a first action if the telephone call is answered before a call alert is initiated or if the telephone call is answered within a time period following the call alert being initiated; and
taking a second action if the telephone call is answered after expiry of the time period following the call alert being initiated.

4. The method according to any of claims 1 to 3, wherein the first action is terminating the call and the second action is allowing the call to proceed.

5. The method according to any of claims 1 to 3, wherein the first action is determining that the call has been answered by a non-human and the second action is determining that the call has been answered by a human.

6. The method of claim 5, wherein the non-human is an answering machine, voicemail, digital assistant, artificial intelligence, a computer, machine, or an interactive voice response, IVR, processor.

7. The method according to any previous claim further comprising the step of receiving a signal indicating that the call alert has been sent.

8. The method according to any previous claim further comprising the steps of:
receiving a signal indicating that the call has been set up; and
receiving a signal indicating that the call is proceeding.

9. The method according to any previous claim, wherein the call alert is a ringing telephone or early media signalling.

10. The method according to any previous claim further comprising the steps of determining that the telephone call has been answered, and determining that the call alert is initiated, based on call progress signalling events.

11. The method according to any previous claim, wherein the first action is to allow the call to proceed provided one or more criteria are met.

12. The method of claim 11, wherein the one or more criteria are any one or more of:
determining that a previous telephone call to the same number or recipient was successful;
determining that the telephone call is the first time that the telephone number or recipient has been called;
determining that a previous telephone call to the same number or recipient exceeded a predetermined time; and/or
determining that a previous telephone call to the same number or recipient was connected to an IVR processor.

13. The method according to any previous claim wherein the telephone call is initiated using voice over session initiation protocol, SIP, IP, VoIP, integrated services digital network, ISDN protocols, or primary rate interface, PRI.

14. A method of analysing telephone call data comprising the step of:
determining from telephone call data that a telephone call was answered by a non-human if the telephone call data indicates that the telephone call was answered before a call alert was initiated.

15. A method of analysing telephone call data comprising the step of:
determining from telephone call data that a telephone call was answered by a non-human if the telephone call data indicates that the telephone call was answered within a time period following a call alert being initiated.

16. A method of analysing telephone call data comprising the step of:
determining from telephone call data that a telephone call was answered by a non-human if the telephone call was answered before a call alert was initiated or if the telephone call was answered within a time period following the call alert being initiated.

17. A system comprising a processor configured to:
initiate a telephone call;
take a first action if the telephone call is answered before a call alert is initiated; and
take a second action if the telephone call is answered after the call alert is initiated.

18. A system comprising a processor configured to:
initiate a telephone call;
take a first action if the telephone call is answered within a time period following a call alert being initiated; and
take a second action if the telephone call is answered after expiry of the time period following the call alert being initiated.

19. A system comprising a processor configured to:
initiate a telephone call;
take a first action if the telephone call is answered before a call alert is initiated or if the telephone call is answered within a time period following the call alert being initiated; and
take a second action if the telephone call is answered after expiry of the time period following the call alert being initiated.

20. The system according to any of claims 17 to 19 further comprising a telephone interface configured to initiate the telephone call.

21. A call centre comprising the system according to any of claims 17 to 20.

22. A computer program comprising program instructions that, when executed on a computer cause the computer to perform the method of any of claim 1 to 16 or 21.

23. A computer-readable medium carrying a computer program according to claim 22.

24. A computer programmed to perform the method of any of claim 1 to 16 or 21.
